(19) United States
(12) Patent Application Publication
(10) Pub. No.: US 2010/0199856 A1
(43) Pub. Date: Aug. 12, 2010

(54) Disposable Roasting Dish

(76) Inventor: Jan Hoermann, Steinhagen (DE)

Correspondence Address: DILWORTH & BARRESE, LLP, 1000 WOODBURY ROAD, SUITE 405, WOODBURY, NY, 11797, US

(21) Appl. No.: 12/512,381

(22) Filed: Jul. 30, 2009

(30) Foreign Application Priority Data
Jul. 31, 2008 (DE) UM202008010268.5

(51) Int. Cl. A47J 37/01

(52) U.S. Cl. 99/422

(57) ABSTRACT

The invention relates to a disposable roasting dish comprising a lower shell and an upper shell which are essentially made of salt.

### BACKGROUND OF THE INVENTION

The invention relates to a disposable roasting dish comprising a lower shell and an upper shell.

Saucepans and roasting dishes are known in the most varied embodiment variants. They are made of the most varied materials and are usually designed for multiple use.

Food can, for example, be cooked in a salt coating in such saucepans and roasting dishes. Such a preparation of food in a salt coating, for example meat or fish, is a particularly gentle cooking process in which it is ensured that the food to be cooked is cooked in its own juices. For this purpose, the food to be cooked is lined with a salt layer, placed into a correspondingly large pan and covered with the salt dough which comprises, for example, a salt coating bound by egg white. The food to be cooked is covered by the salt dough such that the food to be cooked is covered completely tightly. The food to be cooked is then cooked for several hours in an oven correspondingly heated to approximately 200° C. The salt coating has become hard afterward and has to be broken open by a hammer or a meat tenderizer to be able to remove the cooked food. It is an advantage in the cooking in a salt casing that the food to be cooked is prepared as a whole and is hermetically sealed during cooking so that the fat cannot run off during the cooking procedure. An additional salting is furthermore not necessary. The food to be cooked can also be encased with salt on a baking tray without a pot.

It is, however, in particular disadvantageous in the cooking in a pot with a salt crust that the pot has to be lined with a salt layer several centimeters thick and that the food to be cooked then placed thereon likewise has to be lined with the salt. The breaking open of the salt after the cooking and the removal of the salt from the pot after the removal of the cooked food is also very laborious.

### SUMMARY OF THE INVENTION

It is therefore the object of the invention to provide a disposable roasting dish with which food cooked in a salt casing can be prepared in a more simple manner.

This object is solved in accordance with the invention by the teaching herein. Accordingly, a disposable roasting dish comprising a lower shell and an upper shell can be provided which is essentially made up of salt.

Since the roasting dish consists of salt overall, the laborious encasing of the food to be cooked with the salt mass in a conventional pot is no longer necessary. The food to be cooked, for example meat, fish, vegetables or, for example, also desserts such as sweet yeast dumplings, can be placed into the disposable roasting dish and can be cooked accordingly in the oven after the closing of the disposable roasting dish at a temperature corresponding to the food to be cooked.

Further advantageous embodiments of the invention result for the description herein.

Accordingly, the salt of the disposable roasting dish is preferably bound together via an organic adhesive. The salt can hereby be shaped easily in a dough. The parts of the disposable roasting dish can be manufactured simply in a corresponding molding press. In this respect, any desired size and shapes of the disposable roasting dish can be realized. It can, for example, have an appealing fish shape or can also be made correspondingly flat so that it can be used for cooking on a grill (e.g. the plate shape for a pizza).

The organic adhesive advantageously essentially comprises starch, preferably potato starch. Any other organic adhesive, such as egg white, is, however, suitable in a similar manner.

The disposable roasting dish particularly advantageously has the shape of a clay pot roaster. However, any other expedient shape is possible within the framework of the invention.

The base of the disposable roasting dish is, in accordance with another advantageous aspect of the invention, made thicker in its lower shell than the other wall thicknesses. More liquid can hereby be taken up. Predetermined breaking points are in particular provided in the upper part of the disposable roasting dish in the longitudinal and/or transverse directions. They can naturally generally also be provided in the lower part. The disposable roasting dish can hereby be opened more simply after corresponding cooking of the food to be cooked.

Advantageously, handles can be shaped at the side of the upper and/or lower shells. Additionally or alternatively, a holding grip can be shaped at the upper side of the upper shell.

In accordance with a further preferred aspect of the invention, the rim of the upper and/or lower shells can be made in the manner of a flange, with it selectively having one or more gripping recesses.

The lower shell of the disposable roasting dish has obliquely downwardly extending side walls so that the lower shells can be stacked in one another.

Advantageously, a depression for the food to be cooked can be recessed in the base of the lower shell.

### BRIEF DESCRIPTION OF THE DRAWINGS

Further features, details and advantages of the invention will be explained with reference to an embodiment shown in the drawing. There are shown:

FIG. 1: a plan view of a disposable roasting dish in accordance with a first embodiment of the invention;

FIG. 2: a section along the line B-B through FIG. 1;

FIG. 3: a section along the line A-A in accordance with FIG. 1;

FIG. 4: a representation of a plurality of lower shells and upper shells of a disposable roasting dish in stacked form; and

FIGS. 5-8: side views or plan views respectively of the upper part or lower part of the embodiment variant described here of the disposable roasting dish in accordance with the invention.

### DESCRIPTION OF THE PREFERRED EMBODIMENTS

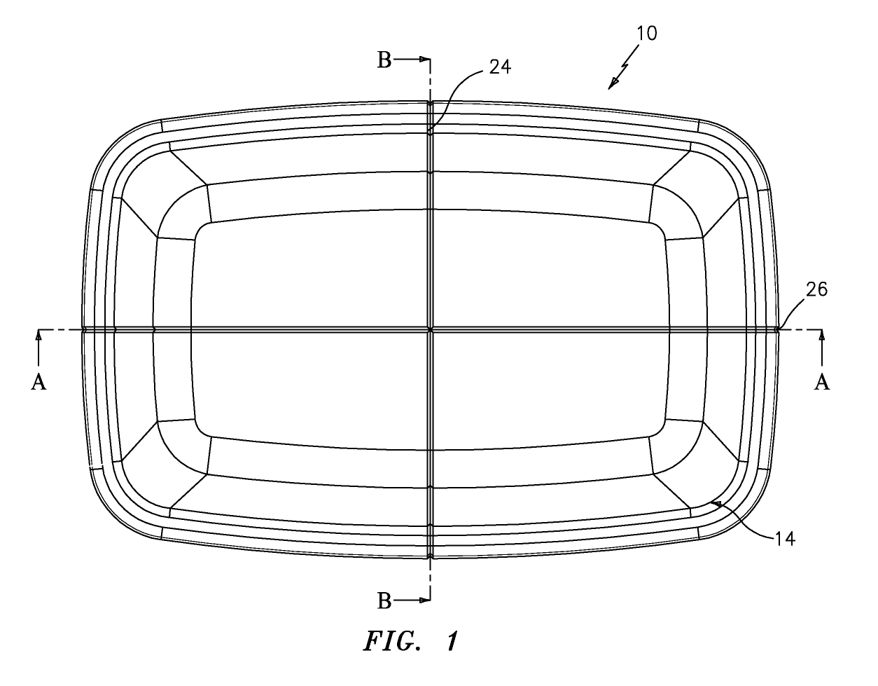

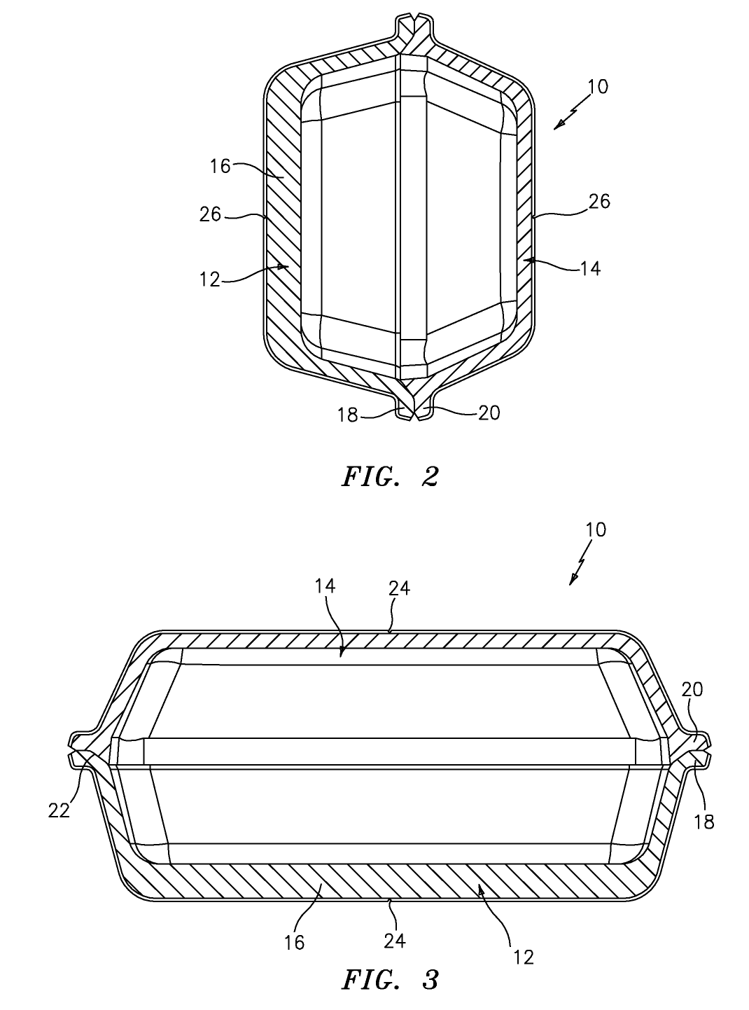

In FIGS. 1 to 3, a disposable roasting dish 10 in accordance with a preferred embodiment of the present invention is shown in plan view and in respective longitudinal and transverse sections. As is in particular shown in the sectional representations in FIGS. 2 and 3, the disposable roasting dish comprises a lower shell 12 and an upper shell 14 which are each essentially made of salt. The shape of the disposable roasting dish 10 corresponds to that of a clay pot roaster. In this respect, the lower shell and the upper shell are made with a similar height. In the embodiment shown here, the base 16 of the lower shell 12 is made thicker than the thickness of the respective walls. Both the lower shell 12 and the upper shell 14 each have flange-like rims 18 and 20 respectively at their outer rims. In the region of the flanges 18 and 20, the upper shell and the lower shell are, as shown in FIGS. 2 and 3, fit into one another in a shape matched manner over obliquely extending edge regions 22 so that the upper shell 14 can be placed matchingly onto the lower shell 12.

The flange-like embodiment of the lower shell 12 and of the upper shell 14 permits a lateral gripping of the disposable roasting dish.

Since the disposable roasting dish forms very solid side walls due to the organic adhesive, preferably salt bound with potato starch, predetermined breaking points 24 and 26 are provided for the easier removal of the cooked food and for the simple destruction of the disposable roasting dish 10 associated therewith. They extend transversely and longitudinally along the upper shell 14 or the lower shell 12.

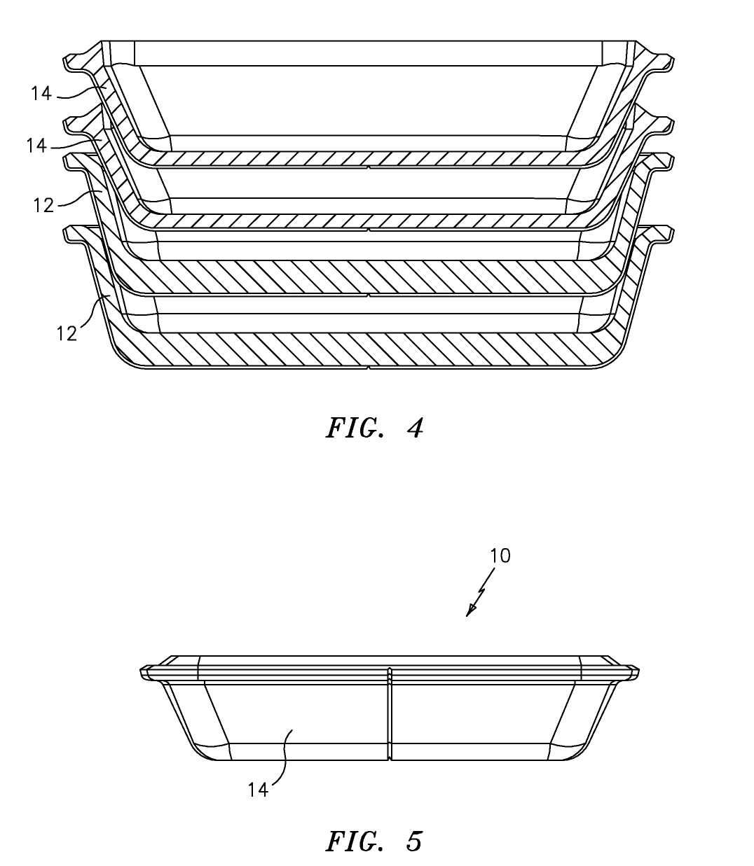

Two respective lower shells 12 and two respective upper shells 14 are stacked on top of one another in FIG. 4. This stacking is possible in that the side walls of the lower shells 12 and upper shells 14 each extend obliquely outwardly.

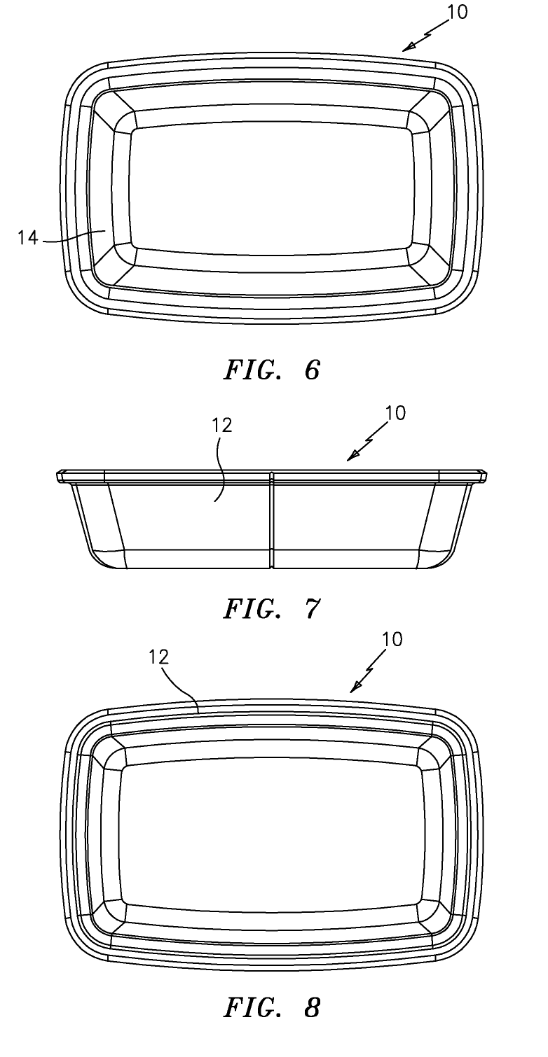

In FIGS. 5 to 8, respective plan views and bottom views as well as side views of the disposable roasting dish 10 are shown, with FIGS. 5 and 6 showing representations of the upper shell 14 and FIGS. 7 and 8 showing representations of the lower shell 12.

1. A disposable roasting dish comprising an upper shell and a lower shell, wherein it is essentially made of salt.

2. A disposable roasting dish in accordance with claim 1, wherein the salt is bound together via an organic adhesive.

3. A disposable roasting dish in accordance with claim 2, wherein the organic adhesive is substantially made of starch, preferably potato starch.

4. A disposable roasting dish in accordance with claim 1, wherein it has the shape of a clay pot roaster.

5. A disposable roasting dish in accordance with claim 1, wherein the base of the lower shell is made thicker than the other wall thicknesses.

6. A disposable roasting dish in accordance with claim 1, wherein predetermined breaking points are in particular provided in the upper part in the longitudinal and/or transverse directions.

7. A disposable roasting dish in accordance with claim 1, wherein handles are shaped at the side of the upper and/or lower shells.

8. A disposable roasting dish in accordance with claim 1, wherein a handle is shaped at the upper side of the upper shell.

9. A disposable roasting dish in accordance with claim 1, wherein the rims of the upper and/or lower shells are made in the manner of a flange and selectively have one or more gripping recesses.

10. A disposable roasting dish in accordance with claim 1, wherein the lower shell has obliquely upwardly extending side walls so that they can be stacked into one another.

11. A disposable roasting dish in accordance with claim 1, wherein a depression for the food to be cooked is recessed in the base of the lower shell.

12. A disposable roasting dish in accordance with claim 2, wherein it has the shape of a clay pot roaster.

13. A disposable roasting dish in accordance with claim 3, wherein it has the shape of a clay pot roaster.

14. A disposable roasting dish in accordance with claim 13, wherein the base of the lower shell is made thicker than the other wall thicknesses.

15. A disposable roasting dish in accordance with claim 4, wherein the base of the lower shell is made thicker than the other wall thicknesses.

16. A disposable roasting dish in accordance with claim 3, wherein the base of the lower shell is made thicker than the other wall thicknesses.

17. A disposable roasting dish in accordance with claim 2, wherein the base of the lower shell is made thicker than the other wall thicknesses.

18. A disposable roasting dish in accordance with claim 17, wherein predetermined breaking points are in particular provided in the upper part in the longitudinal and/or transverse directions.

19. A disposable roasting dish in accordance with claim 16, wherein predetermined breaking points are in particular provided in the upper part in the longitudinal and/or transverse directions.

20. A disposable roasting dish in accordance with claim 15, wherein predetermined breaking points are in particular provided in the upper part in the longitudinal and/or transverse directions.
